(19) United States
(12) Patent Application Publication
(10) Pub. No.: US 2002/0114430 A1
(43) Pub. Date: Aug. 22, 2002

(54) Telephone system for allowing access to both telephone network and computer communication network

(75) Inventor: Toshifumi Murata, Sapporo-Shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: SOFTFRONT, INC., Sapporo-Shi (JP)

(21) Appl. No.: 10/071,985

(22) Filed: Feb. 7, 2002

(30) Foreign Application Priority Data
Feb. 16, 2001 (JP) 2001-39759

(51) Int. Cl. H04L 12/28

(52) U.S. Cl. 379/88.17; 370/351; 379/900

(57) ABSTRACT

The present invention provides a telephone system for allowing access to both a public telephone network and a computer communication network. The telephone system comprises a telephone line signal processing section adapted to be connected with a telephone network to achieve voice communication via the telephone network, and a telephonic function section including a voice input section, a voice output section, an input key section, and an on-hook/off-hook operation section. The telephone system further includes a VoIP engine section adapted to be connected with a computer communication network to achieve voice communication via the computer communication network, and a switching section for switchingly connecting the telephonic function section with either one of the telephone line signal processing section and the VoIP engine section.

### FIELD OF THE INVENTION

The present invention relates to a telephone system. In particular, the present invention relates a telephone system for allowing access to both a telephone network and a computer communication network.

### PRIOR ART

There has been developed a technique for achieving voice communication by use of a personal computer via computer communication networks as represented by the internet, and such technique is just about Stepping in a practical application phase. However, there has not been any technique for allowing a telephone set for public telephone networks to communicate with a personal computer via computer communication networks, and thereby it has been unable to achieve any voice communication between a conventional telephone set and a personal computer. Besides, the voice communication using a personal computer generally increases frustration of users due to its significantly different operation from conventional telephone sets.

### SUMMARY OF THE INVENTION

It is therefore a fundamental object of the present invention to improve a system for voice communication achieved by using a computer communication network so as to provide a user-friendly and convenient communication system.

It is another object of the present invention to provide a telephone system for allowing a telephone set using a public telephone network to achieve voice communicate with a personal computer via a computer communication network.

It is still another object of the present invention to provide a terminal unit for allowing voice communication to be achieved via a computer communication network through a similar operation to that of conventional telephone sets.

It is yet another object of the present invention to provide a telephone system for allowing a long-distance call to be achieved via a computer communication network so as to save telephone charges.

In order to achieve the aforementioned objects, the present invention provides a telephone system for allowing access to both a telephone network and a computer communication network. This telephone system comprises a telephone line signal processing section adapted to be connected with a telephone network to achieve voice communication via the telephone network, and a telephonic function section including a voice input section, a voice output section, an input key section, and an on-hook/off-hook operation section. The telephone system further includes a VoIP engine section adapted to be connected with a computer communication network to achieve voice communication via the computer communication network, and a switching section for switchingly connecting the telephonic function section with either one of the telephone line signal processing section and the VoIP engine section. Further, a control section is provided for generating a signal for controlling the switching section. The control section controls the switching section such that when a first condition is satisfied in respect of each state of the input key section and the on-hook/off-hook operation section, the telephonic function section is connected with one of the telephone line signal processing section and the computer communication network, and when a second condition is satisfied, the telephonic function section is connected with the other one of the telephone line signal processing section and the computer communication network.

In this case, the input key section may include a numeric key and a non-numeric key, wherein the first condition may be defined by a term including the fact that a predetermined specific key provided from the non-numeric key is operated in the input key section under an off-hook state in the on-hook/off-hook operation section. When detecting that this condition is satisfied, the control section is operable for the switching section to connect the telephonic function section with the computer communication network. In the input key section, the numeric key may include 1 to 9-keys and 0-key, and the non-numeric key may include a #-key and a *-key. In this case, the specific key may be the #-key. Further, the second condition may be defined by a term including the fact that any key other than the specific key is operated in the input key section under the off-hook state in the on-hook/off-hook operation section. When detecting that this condition is satisfied, the control section is operable for the switching section to connect the telephonic function section with the telephone network.

In a telephone system according to another aspect of the present invention, a plurality of local communication networks are connected respectively with a wide-area computer communication network through a router and first gateway, wherein each of the local communication networks includes at least one terminal unit connected therewith, each of the local communication networks being connected with a telephone network via a second gateway. The local communication network includes a gatekeeper for opening either one of the first and second gateways to connect the terminal unit with either one of the wide-area computer communication network and the telephone network. The gatekeeper is adapted to open the first gateway to connect the terminal unit with the wide-area computer communication network when a first condition is satisfied in respect to the state of an on-hook/off-hook operation section and an input key section of the terminal unit, and to open the second gateway to connect the terminal unit with the telephone network when a second condition is satisfied.

In this case, the gatekeeper may be adapted to determine which communication with a called end via the wide-area computer communication network or the telephone network provides lower cost, based on a key operated when the input key section is operated for making an outside call under an off-hook state of the on-hook/off-hook operation section of the terminal unit, so as to connect the terminal unit in the local communication network with the determined lower-cost one of the networks. For example, when the above outside call is a long-distance or international call, the gatekeeper connects the outside call with the called end via the wide-area computer communication network.

In another aspect of the present invention, there is provided a voice-communication terminal unit. The voice-communication terminal unit comprises a telephone line signal processing section adapted to be connected with a telephone network to achieve voice communication via the telephone network, and a telephonic function section including, a voice input section, a voice output section, an input key section, and an on-hook/off-hook operation section. The voice-communication terminal unit further includes a VoIP engine section adapted to be connected with a computer communication network to achieve voice communication via the computer communication network, and a switching section for switchingly connecting the telephonic function section with either one of the telephone line signal processing section and the VoIP engine section.

According to another aspect of the present invention, there is provided a voice-communication terminal unit comprising a voice input section, a voice output section, a VoIP engine section adapted to be connected with a computer communication network to achieve voice communication via the computer communication network, and a receiver including an input key section and an on-hook/off-hook operation section.

According to still another aspect of the present invention, there is provided a telephone system comprising a telephone line signal processing section adapted to be connected with a telephone network to achieve voice communication via the telephone network, and a telephonic function section including a voice input section, a voice output section, an input key section, and an on-hook/off-hook operation section. The telephone system further includes a VoIP engine section adapted to be connected with a computer communication network to achieve voice communication via the computer communication network, a switching section for switchingly connecting the telephonic function section with either one of the telephone line signal processing section and the VoIP engine section, and a cost determination section for determining which communication via the telephone network or the computer communication network provides lower cost, based on the operation of the input key section. Further, the telephone system includes a control section for generating a signal for controlling the switching section such that when it is determined that the communication via the telephone network provides lower cost, the telephonic function section is connected with the telephone line signal processing section, and when it is determined that the communication via the computer communication network provides lower cost, the telephonic function section is connected with the VoIP engine section.

### BRIEF DESCRIPTION OF THE DRAWINGS

FIG. 1 is a system diagram showing a telephone system according to one embodiment of the present invention;

FIG. 2 is a schematic diagram showing a terminal unit according to one embodiment of the present invention, which is applicable to a telephone system of the present invention;

FIG. 3 is a functional block diagram showing the terminal unit shown in FIG. 2;

FIG. 4 is a flowchart showing an operation of the telephone system according to the embodiment of the present invention shown in FIGS. 1 to 3, wherein FIG. 4 (a) shows an operation on a calling end, and FIG. 4 (b) shows an operation on a called end;

FIG. 5 is a flowchart showing an operation of a terminal unit different from the terminal unit shown in FIG. 3, according to another embodiment of the present invention;

FIG. 6 is a block diagram corresponding to FIG. 3 and showing a terminal unit according to another embodiment of the present invention;

FIG. 7 is a flowchart showing an operation of a call-waiting circuit in the terminal unit shown in FIG. 6;

FIG. 8 is a flowchart showing an operation of the call-waiting circuit in the terminal unit shown in FIG. 6;

FIG. 9 is a schematic diagram showing a terminal unit according to another embodiment of the present invention;

FIG. 10 is a flowchart showing an operation of a calling end in the terminal unit shown in FIG. 9; and

FIG. 11 is a flowchart showing an operation of a called end of the terminal unit shown in FIG. 9.

### DETAILED DESCRIPTION OF THE PREFERRED EMBODIMENTS

The present invention will now be described in conjunction with specific embodiments illustrated in the drawings.

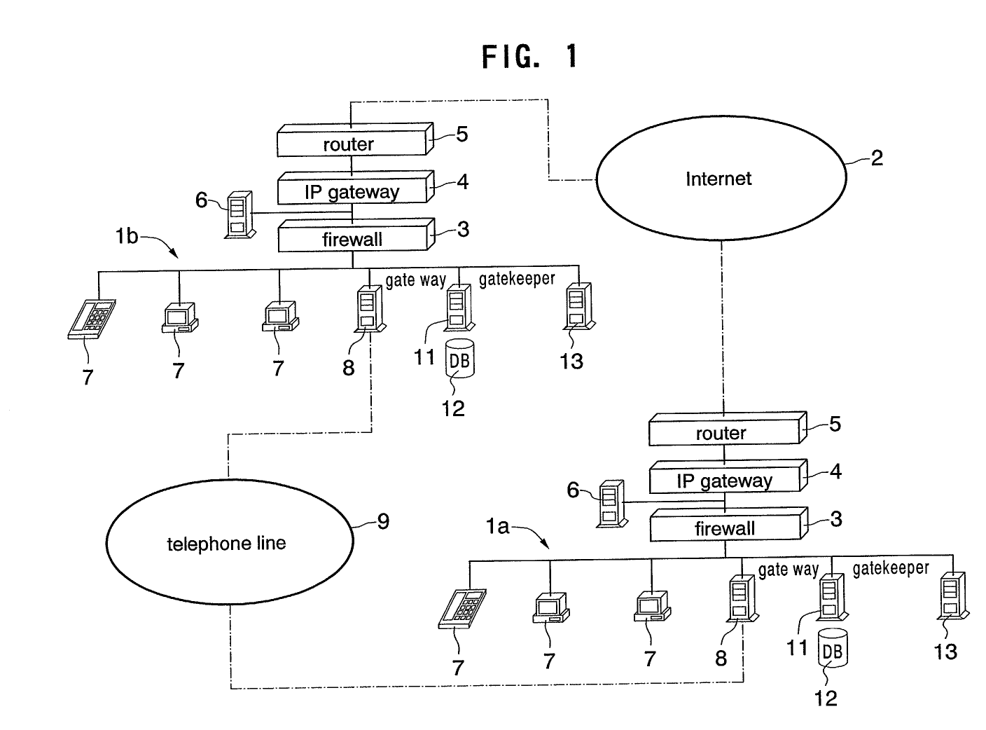

FIG. 1 is a system diagram showing a telephone system according to one embodiment of the present invention. Two local communication networks 1a and 1b are shown in FIG. 1. Each of the local communication networks 1a, 1b are connected with a wide-area computer communication network or the internet 2 via a known firewall 3, an IP gateway 4 and a router 5. A directory server 6 is set up to provide address information of a called end to be connected.

Each of the local communication networks 1a, 1b includes one or more of terminal units 7 connected therewith and capable of achieving both telephonic communication via a public telephone line and voice communication via the internet 2. Each of the local communication networks 1a, 1b further includes a telephone line gateway 8 for connecting the local communication network with a public telephone network 9. Furthermore, each of the local communication networks 1a, 1b includes a gatekeeper 11 for controlling each operation of the IP gateway 4 and the telephone line gateway 8. The gatekeeper 11 has a database 12 for recording a call history of each of the terminal units 7, and an accounting server 13 receives the call history information from the database to calculate a call cost.

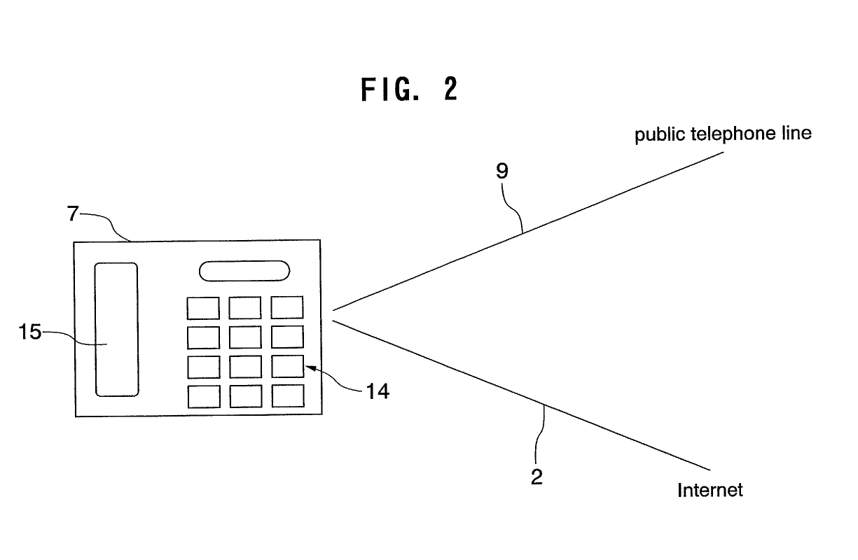

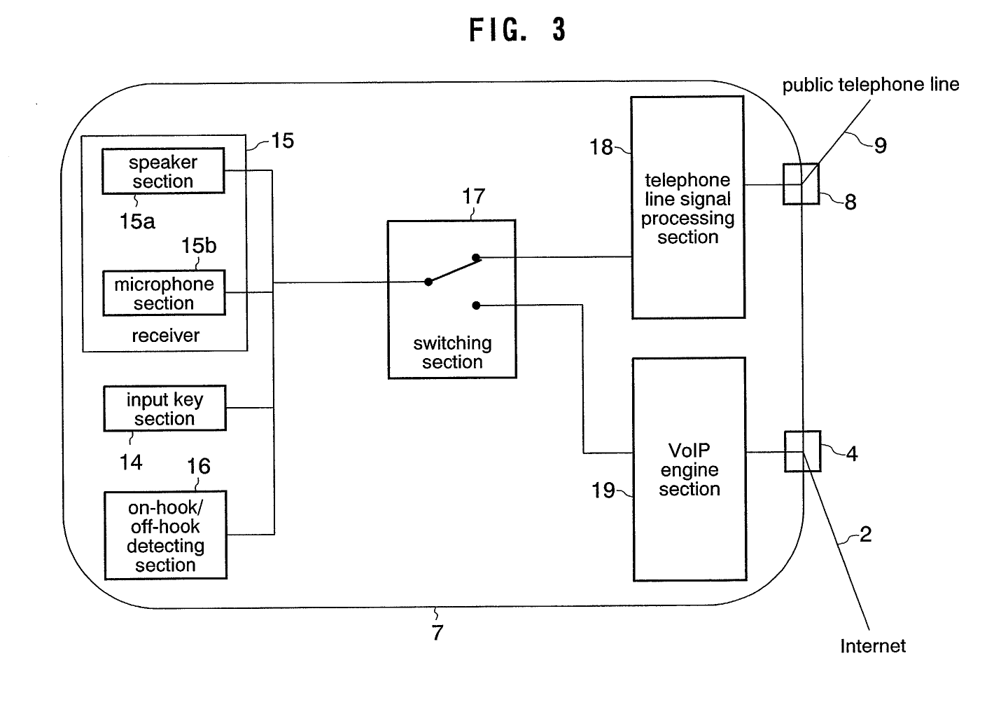

FIG. 2 shows an external view of the terminal unit 7 applicable to a telephone system according to the present invention. In an example shown in FIG. 2, the terminal unit 7 has a similar appearance to a conventional telephone set. However, differently from the conventional telephone set, the terminal unit 7 has a function of connecting not only with the public telephone line but also with the internet 2. FIG. 3 schematically shows the construction of the terminal unit.

Referring to FIGS. 2 and 3, an input key section 14 and a receiver 15 are provided in the terminal unit 7. As shown in FIG. 3, the receiver 15 comprises a speaker section 15a and a microphone section 15b. In association with the receiver 15, a hook switch 16 forming an on-hook/off-hook detecting section is provided to generate a signal corresponding each of an on-hook state and an off-hook state of the receiver 15. The terminal unit 7 includes a telephone line signal processing section 18 adapted to be connected with the public telephone network to achieve voice communication via the telephone network, and a VoIP engine section 19 adapted to be connected with the internet 2 to achieve voice communication via the internet 2. The receiver 15, the input key section 14 and the hook switch 16 are connected alternately or switchingly with either one of the telephone line signal processing section 18 and the VoIP engine section 19 through the switching circuit 17.

The switching circuit 17 is controlled in connection with the IP gateway 4 and the telephone line gateway 8 by the gatekeeper 11 provided in each of the local communication networks 1a, 1b. When the input key is operated for making an outside call, the gatekeeper 11 determines a location of a called end based on the operated key, and then calculates which communication via the public telephone network 9 or the internet 2 determine provides a lower cost for connecting the terminal unit 7 with the called end. When it is determined that the communication via the internet 2 provides lower cost, the terminal unit 7 trying to make the outside call is connected with the called end via the internet 2. Conversely, when it is determined that the communication via the public telephone network 9 provides lower cost, the terminal unit 7 trying to make the outside call is connected with the called end via the public telephone network 9.

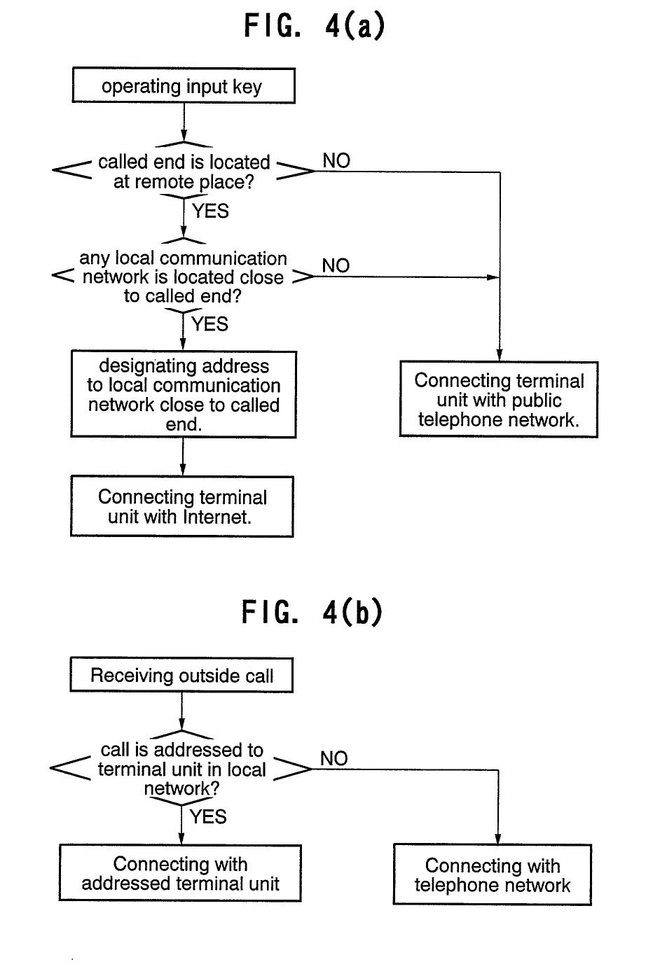

For example, the gatekeeper 11 may carry out the above control based on a call distance or a distance between locations of the call and called ends. FIG. 4 is a flowchart showing one example of such a control. FIG. 4(a) shows an operation of the gatekeeper 11 in the local communication network making an outside call. When the input key section 14 is operated in the terminal unit 7, the gatekeeper 11 determines whether a called end is located at a remote place. When it is determined that the called end is not located at a remote place, e.g. the call is a local call or an out-of-city with a relatively short call distance, the switching circuit 17 in the terminal unit 7 trying to make the outside call is switched to the telephone line signal processing section 18, and the telephone line gateway 8 is opened to connect the terminal unit 7 with the telephone network 9.

When the called end is located at a remote place, it is determined whether the local communication network is located close to the location of the called end. If the local communication network is not located close to the location of the called end, the gatekeeper 11 switches the switching circuit 17 of the terminal unit 7 trying to make the outside call to the telephone line signal processing section 18, and the telephone line gateway 8 is opened to connect the terminal unit 7 with the telephone network 9, as in the local call. If the local communication network is located close to the location of the called end, the gatekeeper 11 designates the internet address as that of the local communication network to connect the terminal unit 7 trying to make the outside call with the internet 2. In this case, a telephone number information of the called end is transmitted to the local communication network close to the location of the called end via the internet 2.

FIG. 4(b) is a flowchart showing an operation of the gatekeeper 11 in the local communication network of the called end. When receiving the outside call, the gatekeeper 11 determines whether the call is addressed to the terminal unit 7 in the local communication network of the called end. When it is determined that the call is addressed to the terminal unit 7 in the local communication network of the called end, the gatekeeper 11 operates the switching circuit 17 of the addressed terminal unit 7 to connect the call through to the terminal unit 7.

If the received outside call is addressed to a telephone set outside the local communication network of the called end, the gatekeeper 11 connects the received outside call through to the public telephone network 9.

According to the aforementioned control, in a call to a remote place, the voice communication can be achieved via the internet 2. This allows communication cost to be desirably reduced. For example, in the telephone system as shown in FIG. 1, if one local communication networks 1a is provided in a head office located at Sapporo, and the other local communication networks 1b is provided in the branch office located at Tokyo, all or a part of calls from Sapporo to Tokyo or its suburbs can be made via the internet to reduce telephone costs. The same goes for international calls. For example, if one local communication networks 1a is provided at Tokyo and the other local communication networks 1b is provided at New York, vice communication can be achieved through these local communication networks to provide significantly reduce telephone costs. In an enterprise having a number of branches all over the world, a local communication network can be provided a head office and each of branches to allow voice communication to be achieved through these local communication networks. This allows telephone costs to be significantly saved.

The terminal unit 7 shown in FIG. 3 can function in isolation by connecting directly with the internet 2 or the telephone network 9 without any connection through the local communication network as shown in FIG. 1. In this case, the telephone line signal processing section 18 in the terminal unit 7 and the VoIP engine section 19 are directly connected with the telephone network 9 and the internet 2, respectively. In this arrangement, when the hook switch 16 detects off-hook, an off-hook signal is output from the hook switch 16 to the switching section 17.

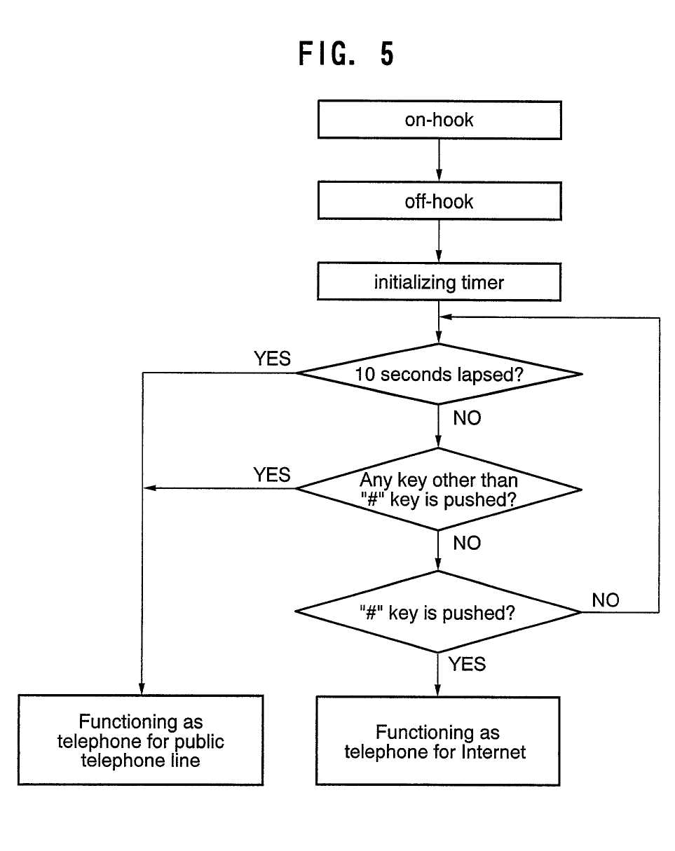

FIG. 5 is a flowchart showing an operation of the switching section 17. When the hook switch 16 detects off-hook, a timer starts counting. Then, it is determined whether a predetermined key, for example, a “#” key in the input key section 14 is pushed within a given time period, e.g. 10 seconds, after the off-hook has been detected. If it is determined that the “#” key is pushed within the given time period, the switching section 17 operates to provide the connection with the VoIP engine section 19. Thus, the terminal unit 7 is connected with the internet 2 to allow voice communication via the internet.

When it is determined that no key is pushed within the given time period or any key other than the “#” key is pushed within the given time period, the switching section 17 operates to provide the connection with the telephone line signal processing section 18. Thus, the terminal unit 7 is connected with the telephone network 9 to allow the same handling as conventional telephone sets. In this embodiment, the fact that the “#” key is pushed within the predetermined time period corresponds to a first condition of the present invention. The fact that no key is pushed within the given time period or any key other than the “#” key is pushed within the given time period corresponds to a second condition of the present invention.

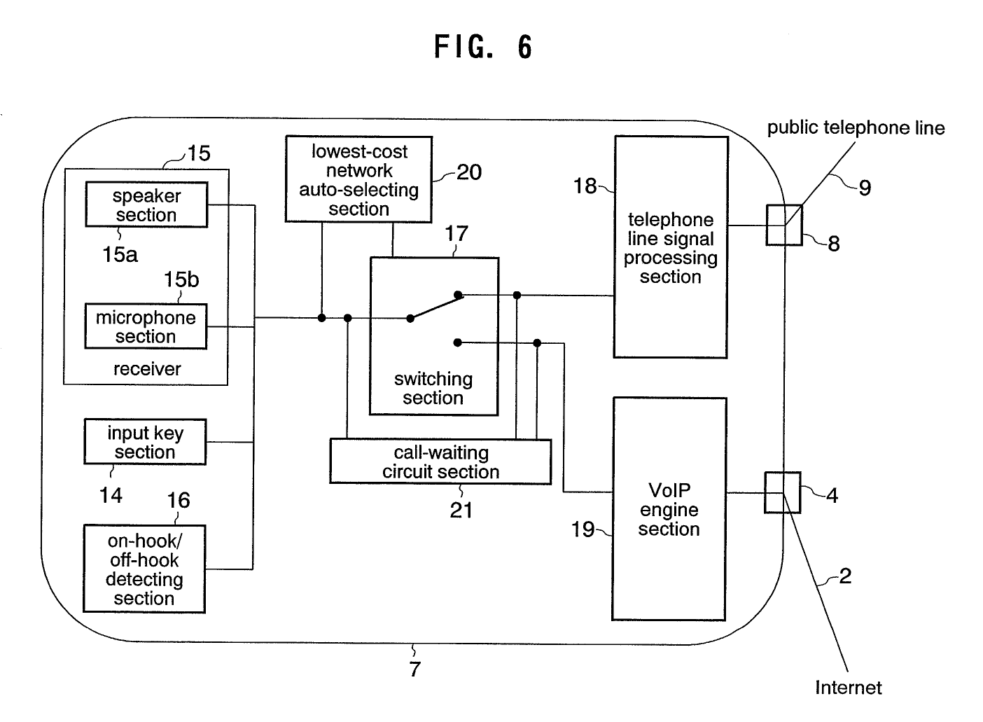

FIG. 6 is a diagram corresponding to FIG. 3 and showing another embodiment of the present invention. A terminal unit 7 of this embodiment is different from the terminal unit shown in FIG. 3 in that a switching section 17 of this embodiment additionally includes a lowest-cost network auto-selecting section 20 and a call-waiting circuit section 21.

In the embodiment shown in FIG. 6, when the input key section 14 is operated to make an outside call, the lowest-cost network auto-selecting section 20 recognizes a location of a called end based on the operated key, and then determines which use of the internet 2 or the public telephone network 9 provides lower cost. When it is determined that the use of the public telephone network 9 provides lower cost, the lowest-cost network auto-selecting section 20 operates the switching section 17 to provide the connection with the telephone line signal processing section 18. Conversely, when it is determined that the use of the internet 2 provides lower cost, the lowest-cost network auto-selecting section 20 operates the switching section 17 to provide the connection with the VoIP engine section 19.

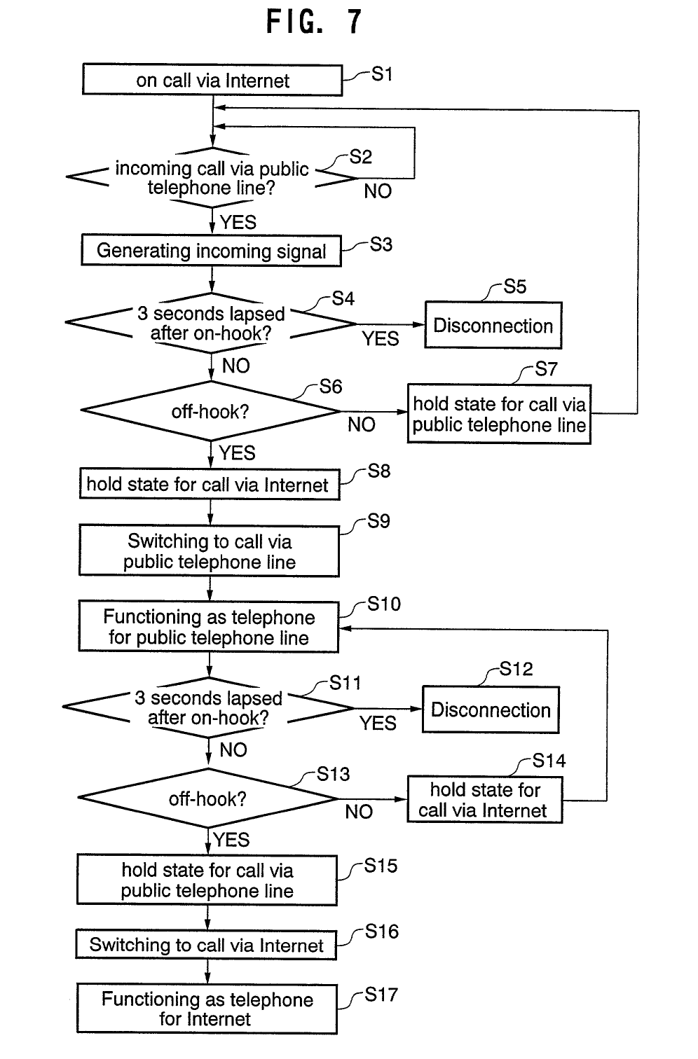

Now, an operation of the call-waiting circuit 21 in the terminal unit 7 will be described. FIG. 7 is a flowchart showing the operation of the call-waiting circuit 21 when an external call or incoming call is received via the public telephone line 9 while the terminal unit 7 is conducting voice communication via the internet 2. When an incoming call via the public telephone line 9 is detected in Step S2, an incoming signal is generated in Step S3, and the speaker section 15a of the terminal unit 7 produces an incoming sound, such as ring. At this moment, if the user of the terminal unit 7 on the voice communication via the internet prefers a response to the calling via the public telephone network 9, the user can on-hook the receiver 15 and then off-hook within a given time period, e.g. 3 seconds. If the on-hook state is kept for 3 seconds or more, both calls via the internet and the public telephone line will be disconnected. In Step S7, until 3 seconds have lapsed under the on-hook state without any off-hook, the call via the public telephone line is kept in a hold state. In Step S6, when the hook switch 16 detects off-hook before the given time period has lapsed, the call-waiting circuit 21 performs a hold processing for the voice communication via the internet 2 in Step S8. Then, in Step S9, the call-waiting circuit 21 operates the switching section 17 to provide the connection with the telephone line signal processing section 18. This allows voice communication via the public telephone network 9, and the external call can be received by off-hooking the receiver 15, as shown in Step S10. In Step S11, if the receiver 15 is on-hooked and then off-hooked within a given time period, e.g. 3 seconds, the hold processing for the call via the public telephone network 9 is conducted in Step S15. Then, in Step S16, the switching section 17 is operated to restart the voice communication via the internet 2 which has been in the hold state. In Step S11, if the on-hook state is kept for 3 seconds or more, both the calls via the internet and the public telephone line will be disconnected. In Step S13, until 3 seconds have lapsed under the on-hook state without any off-hook, the call via the internet 2 is kept in the hold state.

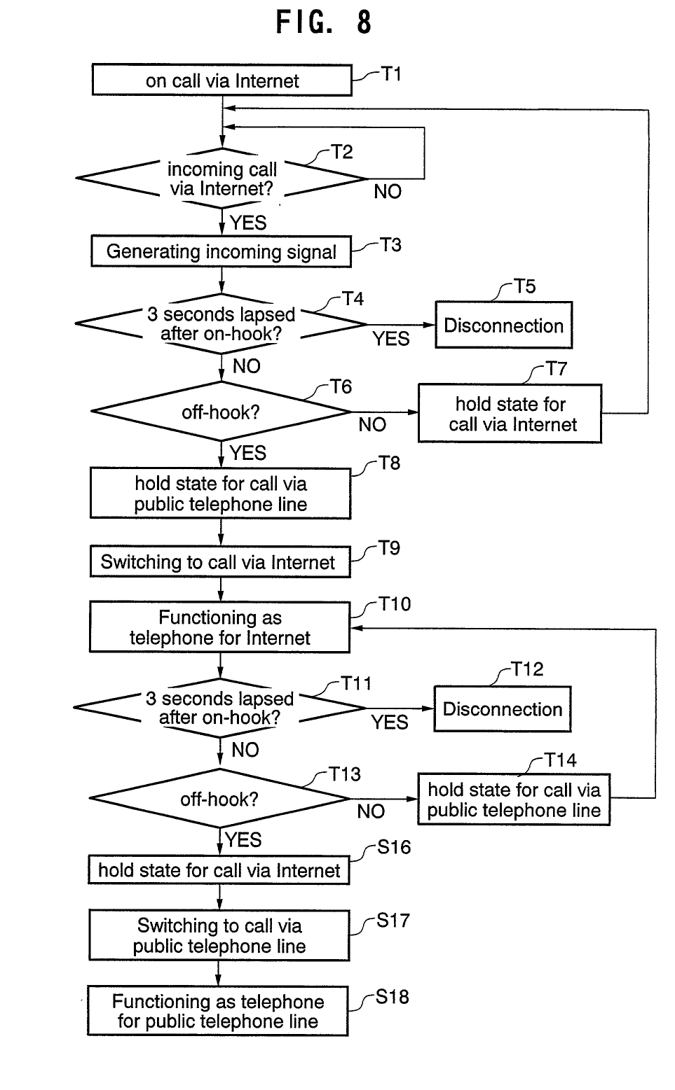

FIG. 8 is a flowchart showing an operation of the call-waiting circuit 21 when an external call is received via the internet 2 while the terminal unit 7 is conducting voice communication via public telephone network 9. When an incoming call via the internet 2 is detected in Step T2, an incoming signal is generated in Step T3, and the speaker section 15a of the terminal unit 7 produces an incoming sound. At this moment, if the user of the terminal unit 7 on the voice communication via the public telephone network 9 prefers a response to the calling via the internet, the user can on-hook the receiver 15 and then off-hook within a given time period, e.g. 3 seconds. If the on-hook state is kept for 3 seconds or more, both calls via the internet and the public telephone line will be disconnected. In Step T7, until 3 seconds have lapsed under the on-hook state without any off-hook, the call via the internet 2 is kept in a hold state. In Step T6, when the hook switch 16 detects off-hook before the given time period has lapsed, the call-waiting circuit 21 performs a hold processing for the voice communication via the public telephone network 9 in Step T8. Then, in Step T9, the call-waiting circuit 21 operates the switching section 17 to provide the connection with the VoIP engine section 19. This allows voice communication via the internet 2, and the external call can be received by off-hooking the receiver 15, as shown in Step T10. In Step T11, if the receiver 15 is on-hooked and then off-hooked within a given time period, e.g. 3 seconds, the hold processing for the call via the internet 2 is conducted in Step T15. Then, in Step T16, the switching section 17 is operated to restart the voice communication via the public telephone network 9 which has been in the hold state. In Step T11, the receiver 15 is on-hooked and then off-hooked within a given time period, e.g. 3 seconds. If the on-hook state is kept for 3 seconds or more, both the calls via the internet and the public telephone line will be disconnected. In Step T13, until 3 seconds have lapsed under the on-hook state without any off-hook, the call via the public telephone network 9 is kept in the hold state.

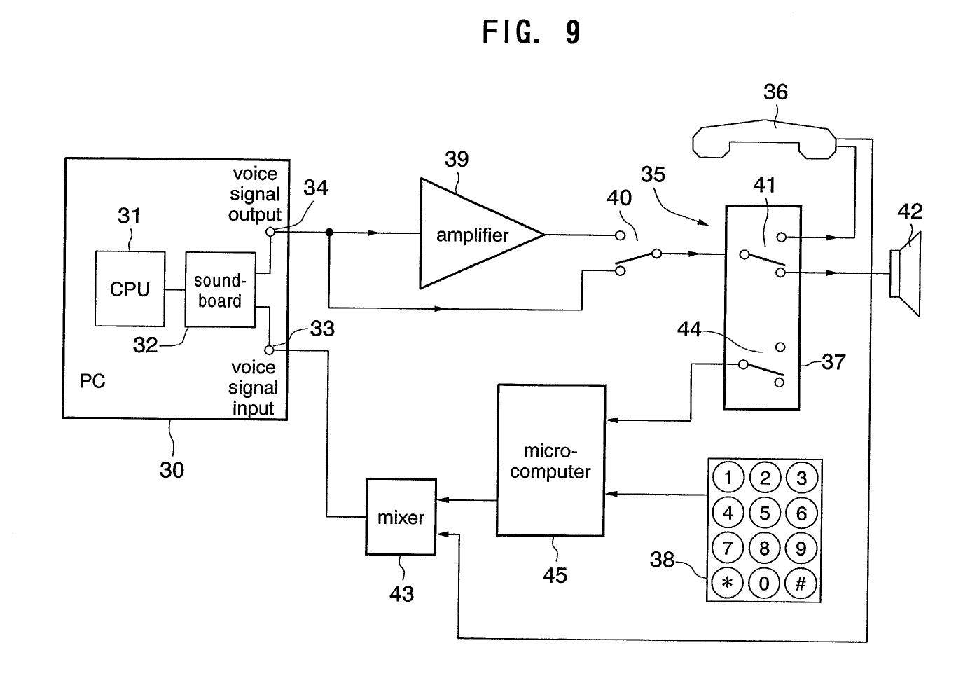

For implementing the present invention, the terminal unit 7 may additionally employ any desired function of a personal computer having a soundboard. In this case, in order to provide a similar operational feeling to conventional telephone sets for users, it is preferable to provide a similar receiver to conventional telephone sets in a personal computer. FIG. 9 shows one example.

In FIG. 9, a personal computer 30 comprises a CPU 31 and a soundboard 32. The personal computer 30 also includes a voice-signal input section 33 and a voice-signal output section 34 associated with the soundboard 32. As in conventional telephone sets, a receiver set 35 includes a receiver 36 and a receiver rest 37. The receiver 36 has a conventional structure including a speaker section and a microphone section. An input key section 38 is provided in the receiver set 35. The input key section 38 may be incorporated in either the receiver 36 or the receiver rest 37.

The receiver 36 is connected with the voice-signal input section 33 and with the voice-signal output section 34 of the personal computer 30. More specifically, the voice-signal output section 34 of the personal computer 30 is connected to a changing-over switch 41 in the receiver rest 37 through an amplifier 39 and an amplifier switch 40. The amplifier switch 40 has two contacts. One of the contacts is connected with the amplifier 39, and the other is connected directly with the voice-signal output section 34 of the personal computer 30. The common contact of the amplifier switch 40 is connected with the common contact of the changing-over switch 41 in the receiver rest 37. The changing-over switch 41 includes two changing-over contacts; one is connected with the speaker section of the receiver 36, and the other is connected with a speaker 42. Thus, a voice output can be obtained from either one of the speaker section in the receiver 36 and the speaker 42 by switching the changing-over switch 41. The contacts of changing-over switch 41 is changed over according to the on-hook/off-hook operation of the receiver 36 to connect the common contact of the amplifier switch 40 with the speaker 42 in the on-hook state and with the speaker section of the receiver 36 in the off-hook state.

Further, by switching the amplifier switch 40, the voice signal may be transmitted to the speaker section of the receiver 36 or to the speaker 42 through the amplifier 39, or directly to the speaker section of the receiver 36 or the speaker 42 by bypassing the amplifier 39. The microphone section of the receiver 36 is connected with the voice-signal input section 33 of the personal computer 30 through a mixer 43.

The receiver rest 37 further includes a hook switch 44 for detecting the hook state of the receiver 36. The hook switch 44 is connected with a PIC microcomputer 45 which functions to form different electronic sound signals depending on input signals. When the receiver 36 is on-hooked and off-hooked, the PIC microcomputer 45 receives signals from the hook switch 44 and generates signals for forming corresponding electronic sounds.

The input key section 38 is also connected with the PIC microcomputer 45 to generate signals for forming different electronic sounds corresponding to the input keys operated. An output section 45 of the PIC microcomputer 45 is connected with the mixer 43, and an output signals from the PIC microcomputer 45 are input into the voice-signal input section 33 of the personal computer 30 through the mixer 43.

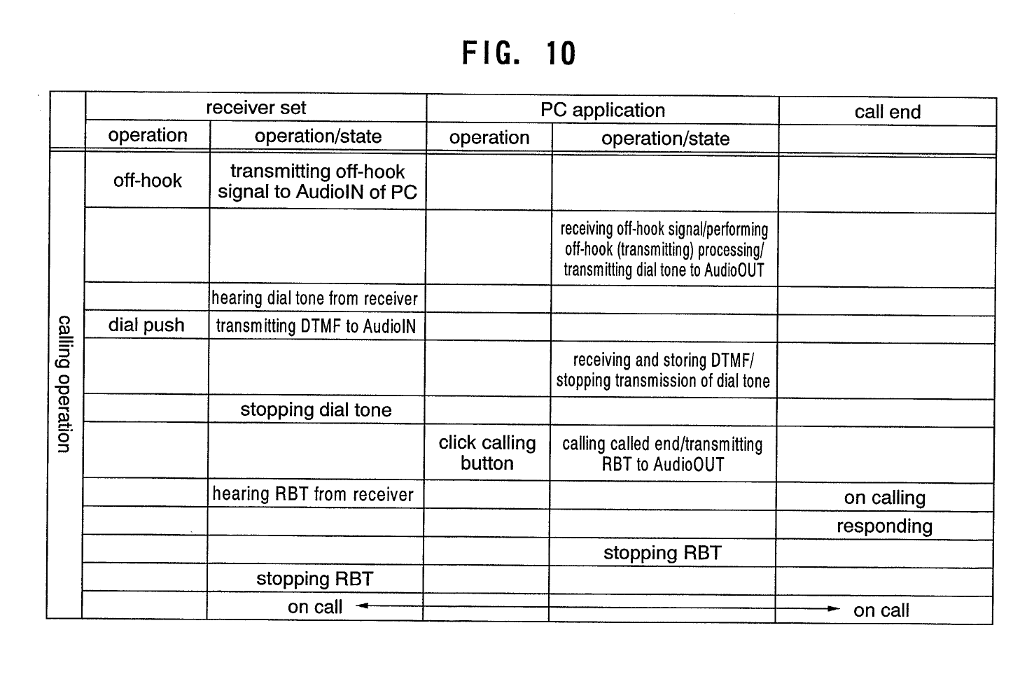

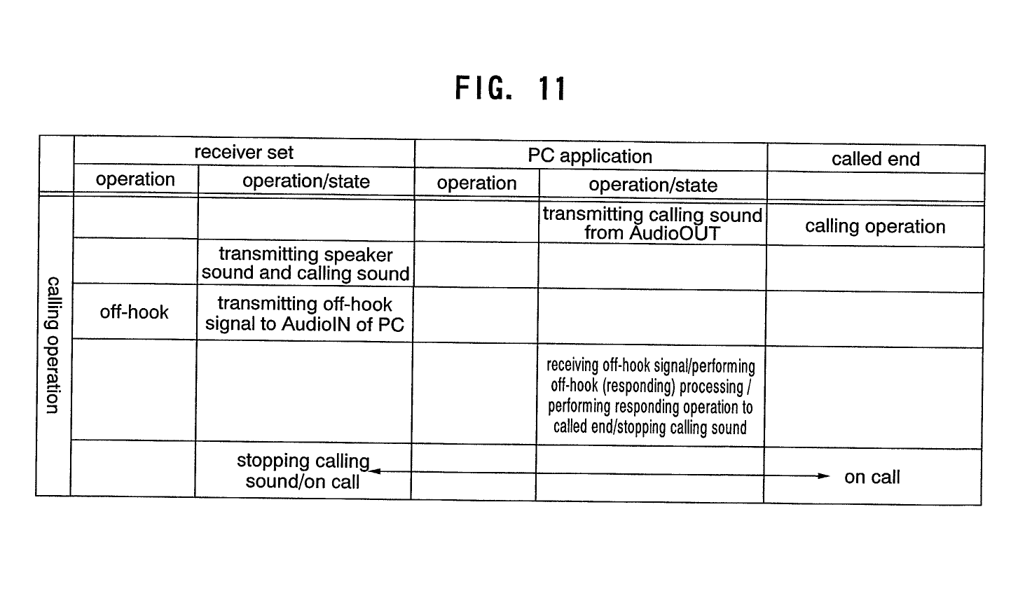

FIGS. 10 and 11 are flowcharts showing operations of the terminal unit 7 shown in FIG. 9 in calling and receiving, respectively. Referring to FIG. 10, the calling operation for calling starts with the off-hook operation in which the receiver 36 is detached from the receiver rest 37. By the off-hook operation, a trigger signal is transferred from the hook switch 44 to the PIC microcomputer 45, and then an electronic sound signal generated by the PIC microcomputer 45 is input as an off-hook signal into the voice-signal input section 33 of the personal computer 30 through the mixer 43.

At this moment, the personal computer 30 performs a processing for the received off-hook signal to form a dial tone signal. The dial tone signal is output from the voice-signal output section 34 of the personal computer 30 to the receiver 36. Thus, the user can hear a dial tone from the receiver 36. Then, in the receiver set 35, the telephone number of the called end is dialed by operating the input keys on the input key section 38. According to this dialing operation, a dual tone multi-frequency (DTMF) is output from the PIC microcomputer 45 and this DTMF is input into the voice-signal input section 33 of the personal computer 30. The personal computer 30 receives and stores this DTMF. Simultaneously, the transmitting of the dial tone is stopped. Then, if the user operates a calling button provided on the personal computer 30 or the receiver set 35, an RBT for calling the called end will be output from the voice-signal output section 34 of the personal computer 30. This RBT can be heard from the receiver 36 on the calling end. At this moment, a calling starts on the called end. In response to this calling, if the called end takes the call, the RBT will be stopped. Then, the calling end can perform voice communication with the called end.

Referring to FIG. 11, the personal computer 30 in the terminal unit 7 of the called end outputs a calling sound signal from the voice-signal output section 34 in response to the calling from outside. Thus, a calling sound is provided from the speaker 42 of the receiver set 35. Then, the user of the terminal unit 7 on the called end off-hooks the receiver 36. In response to this operation, the hook switch 44 provided in the receiver rest 37 of the receiver set 35 is activated, and an electronic sound signal corresponding to the off-hook operation of the receiver 36 is generated by the PIC microcomputer 45. This electronic sound signal is input into the voice-signal input section 33 of the personal computer 30 on the called end as an off-hook signal. The personal computer 30 on the called end receives this off-hook signal to perform an off-hook processing. That is, the personal computer 30 stops the calling sound to allow voice communication.

After above operations, voice communication is started. When the receiver in either one of the terminal units 7 is on-hooked, the voice communication terminates. It is to be understood that the personal computer 30 of the terminal unit 7 shown in FIG. 9 may employ the telephone line signal processing section 18 for allowing voice communication via the public telephone network 9 in addition to the VoIP engine section 18 for allowing the voice communication via the internet 2.

What is claimed is:

1. A telephone system for allowing access to both a telephone network and a computer communication network, said telephone system comprising:
a telephone line signal processing section adapted to be connected with a telephone network to achieve voice communication via said telephone network;
a telephonic function section including a voice input section, a voice output section, an input key section, and an on-hook/off-hook operation section;
a VoIP engine section adapted to be connected with a computer communication network to achieve voice communication via said computer communication network;
a switching section for switchingly connecting said telephonic function section with either one of said telephone line signal processing section and said VoIP engine section; and
a control section for generating a signal for controlling said switching section such that when a first condition is satisfied in respect of each state of said input key section and said on-hook/off-hook operation section, said telephonic function section is connected with one of said telephone line signal processing section and said computer communication network, and when a second condition is satisfied, said telephonic function section is connected with the other one of said telephone line signal processing section and said computer communication network.

2. A telephone system as defined in claim 1, said input key section includes a numeric key and a non-numeric key, wherein said first condition is defined by a term including the fact that a predetermined specific key provided from said non-numeric key is operated in said input key section under an off-hook state in said on-hook/off-hook operation section, wherein when detecting that said first condition is satisfied, said control section is operable for said switching section to connect said telephonic function section with said computer communication network.

3. A telephone system as defined in claim 2, said numeric key includes 1 to 9-keys and 0-key, and said non-numeric key includes a #-key and a *-key, wherein said specific key is said #-key.

4. A telephone system as defined in claim 2 or 3, said second condition is defined by a term including the fact that any key other than said specific key is operated in the input key section under the off-hook state in said on-hook/off-hook operation section, wherein when detecting that said second condition is satisfied, said control section is operable for said switching section to connect said telephonic function section with said telephone network.

5. A telephone system for allowing access to both a telephone network and a computer communication network, in which a plurality of local communication networks are connected respectively with a wide-area computer communication network through a router and a first gateway, each of said local communication networks including at least one terminal unit connected therewith, each of said local communication networks being connected with a telephone network via a second gateway, wherein
each of said local communication networks includes a gatekeeper for opening either one of said first and second gateways to connect said terminal unit with either one of said wide-area computer communication network and said telephone network, said gatekeeper being adapted to open said first gateway to connect said terminal unit with said wide-area computer communication network when a first condition is satisfied in respect to the state of an on-hook/off-hook operation section and an input key section of said terminal unit, and to open said second gateway to connect said terminal unit with said telephone network when a second condition is satisfied.

6. A telephone system as defined in claim 5, wherein said gatekeeper is adapted to determine which communication with a called end via said wide-area computer communication network or said telephone network provides lower cost, based on a key operated when said input key section is operated for a calling under an off-hook state of said on-hook/off-hook operation section of said terminal unit, so as to connect said terminal unit in said local communication network with said determined lower-cost one of said networks.

7. A telephone system as defined in claim 5, wherein said gatekeeper is adapted to determine that said first condition is satisfied, when said gatekeeper recognizes that said called end is located at a remote place, based on a key operated when said input key section is operated for making an outside call under the off-hook state of said on-hook/off-hook operation section of said terminal unit, so as to connect said terminal unit making said outside call with the local communication network close to the location of said called end via said wide-area computer communication network, wherein when said called end is the terminal unit connected with said local communication network, the gatekeeper of said local communication network close to the location of said called end is adapted to connect said outside call with said terminal, and when said called end is a telephone set connected with the outside telephone network, the gatekeeper of said local communication network close to the location of said called end is adapted to connect said outside call with said outside telephone network.

8. A telephone system as defined in claim 7, wherein said outside call is an overseas call.

9. A voice-communication terminal unit comprising:
a telephone line signal processing section adapted to be connected with a telephone network to achieve voice communication via said telephone network;
a telephonic function section including a voice input section, a voice output section, an input key section, and an on-hook/off-hook operation section;
a VoIP engine section adapted to be connected with a computer communication network to achieve voice communication via said computer communication network; and
a switching section for switchingly connecting said telephonic function section with either one of said telephone line signal processing section and said VoIP engine section.

10. A voice-communication terminal unit comprising:
a voice signal input section;
a voice signal output section;
a VoIP engine section adapted to be connected with a computer communication network to achieve voice communication via said computer communication network; and
a receiver set including an input key section and allowing an on-hook/off-hook operation, wherein said receiver set is connected with said voice signal input section and said voice signal output section.

11. A telephone system comprising:
a telephone line signal processing section adapted to be connected with a telephone network to achieve voice communication via said telephone network;
a telephonic function section including a voice input section, a voice output section, an input key section, and an on-hook/off-hook operation section;
a VoIP engine section adapted to be connected with a computer communication network to achieve voice communication via said computer communication network;
a switching section for switchingly connecting said telephonic function section with either one of said telephone line signal processing section and said VoIP engine section; and
a cost determination section for determining which communication via said telephone network or said computer communication network provides lower cost, based on the operation of said input key section; and
a control section for generating a signal for controlling said switching section such that when it is determined that the communication via said telephone network provides lower cost, said telephonic function section is connected with said telephone line signal processing section, and when it is determined that the communication via said computer communication network provides lower cost, said telephonic function section is connected with said VoIP engine section.
